(19) United States
(12) Patent Application Publication
(10) Pub. No.: US 2015/0029439 A1
(43) Pub. Date: Jan. 29, 2015

(54) BACKLIGHT ASSEMBLY AND LIQUID CRYSTAL DISPLAY HAVING THE SAME

(71) Applicant: Samsung Display Co., Ltd., Yongin-City (KR)

(72) Inventors: JoongHyun KIM, Asan-si (KR); DONGHOON KIM, Suwon-si (KR); Young-Jun SEO, Seoul (KR); Daehoon SONG, Seoul (KR); Young-keun LEE, Suwon-si (KR); Youngjun CHOI, Yongin-si (KR)

(73) Assignee: Samsung Display Co., Ltd., Yongin-City (KR)

(21) Appl. No.: 14/156,917

(22) Filed: Jan. 16, 2014

(30) Foreign Application Priority Data
Jul. 29, 2013 (KR) 10-2013-0089560

(51) Int. Cl. G02F 1/1335; F21K 99/00

(52) U.S. Cl. CPC G02F 1/133605; F21K 9/56
USPC 349/64; 362/97.1

(57) ABSTRACT

A back light assembly includes: a light source including a light emitting diode which generates white light having color coordinates located on one of a plurality of color coordinate ranks; a reflector sheet which reflects the white light incident from the light source, where the reflector sheet includes a reflective material which reflects light incident thereon and a color compensation material which compensates the color coordinates of the white light by controlling the intensity of light having a predetermined wavelength range, among the white light, to allow the color coordinates of the white light to converge on target color coordinates; and a diffuser plate which diffusing light provided from the light source and the reflector sheet.

This application claims priority to Korean Patent Application No. 10-2013-0089560, filed on Jul. 29, 2013, and all the benefits accruing therefrom under 35 U.S.C. §119, the content of which in its entirety is herein incorporated by reference.

### BACKGROUND

1. Field

The present disclosure relates to a back light assembly and a liquid crystal display apparatus including the back light assembly, and more particularly, to a back light assembly emitting back light having uniform color coordinates independently of color coordinates of white light emitted from a light source and a liquid crystal display apparatus including the back light assembly.

2. Description of the Related Art

Generally, a liquid crystal display (“LCD”) apparatus includes an LCD panel for displaying images and a back light assembly for supplying light to the LCD panel.

The back light assembly may be classified into edge type assemblies and direct type assemblies based on a position of a light source for generating light. An edge type back light assembly has a configuration in which a light source is disposed on a side surface of a light guide plate, and a direct type back light assembly has a configuration in which a plurality of light sources is disposed below of a diffuser plate.

The light source may include a light emitting diode (“LED”) that emits white light, and the LED includes a light source fluorescent body. Amounts of light source fluorescent bodies included in various LEDs may be different from each other, and the color coordinates of the light emitted from back light assemblies including the various LEDs, respectively, may be different from each other.

### SUMMARY

The present disclosure provides a back light assembly emitting back light having uniform color coordinates independently of color coordinates of white light emitted from a light source, and a liquid crystal display apparatus including the back light assembly.

An embodiment of the invention provides a back light assembly including a light source including a light emitting diode which generates white light having color coordinates located on one of a plurality of color coordinate ranks, a reflector sheet which reflects the white light incident from the light source, where the reflector sheet includes a reflective material which reflects light incident thereon and a color compensation material which compensates the color coordinates of the white light by controlling intensity of light having a predetermined wavelength range, among the white light, to allow the color coordinates of the white light to converge on target color coordinates, and a diffuser plate which diffusing light provided from the light source and the reflector sheet.

In some embodiments, the color compensation material may include absorption pigments which absorb the light having the predetermined wavelength among the white light.

In other embodiments, an x-coordinate value of the color coordinates of the white light may be less than an x-coordinate value of the target color coordinates or a y-coordinate value of the color coordinates of the white light may be less than a y-coordinate value of the target color coordinates, and the absorption pigments may increase at least one of the x-coordinate value and the y-coordinate value of the color coordinates of the white light.

In still other embodiments, the absorption pigments may absorb light having a wavelength in a range from about 350 nanometers (nm) to about 500 nm, among the white light.

In even other embodiments, an absorption spectrum of the absorption pigments may have absorption intensity of about 10% or less of maximum absorption intensity of the absorption pigments, at a wavelength of about 500 nm.

In yet other embodiments, the absorption spectrum of the absorption pigments may overlap at least a portion of a blue light emitting spectrum among light emitting spectrums of the light emitting diode.

In further embodiments, the light emitting diode may generate light having a wavelength in a range from about 430 nm to about 450 nm, a wavelength of the absorption pigments having maximum absorption intensity may be located within from about 430 nm to about 450 nm, and a half width of the absorption spectrum of the absorption pigments may be in a range from about 15 nm to about 30 nm.

In still further embodiments, the absorption pigments may include azo pigments, phthalocyanine pigments, dye mordant pigments, condensed polycyclic pigments, and a combination thereof.

In even further embodiments, an x-coordinate value of the color coordinates of the white light may be greater than an x-coordinate value of the target color coordinates or a y-coordinate value of the color coordinates of the white light may be greater than a y-coordinate value of the target color coordinates, and the absorption pigments may reduce at least one of the x-coordinate value and the y-coordinate value of the color coordinates of the white light.

In yet further embodiments, the absorption pigments may absorb light having a wavelength in a range from about 500 nm to about 800 nm among the white light.

In much further embodiments, the color compensation material may include a fluorescent body.

In still much further embodiment, an x-coordinate value of the color coordinates of the white light may be less than an x-coordinate value of the target color coordinates or a y-coordinate value of the color coordinates of the white light may be less than a y-coordinate value of the target color coordinates, and the fluorescent body may increase at least one of the x-coordinate value and the y-coordinate value of the color coordinates of the white light.

In even much further embodiments, the fluorescent body may generate light including light having a wavelength in a range from about 500 nm to about 800 nm.

In yet much further embodiments, an x-coordinate value of the color coordinates of the white light may be greater than an x-coordinate value of the target color coordinates or a y-coordinate value of the color coordinates of the white light may be greater than a y-coordinate value of the target color coordinates, and the fluorescent body may reduce at least one of the x-coordinate value and the y-coordinate value of the color coordinates of the white light.

In other embodiments, the fluorescent body may generate light including light having a wavelength in a range from about 350 nm to about 500 nm.

In other embodiments, the color compensation material may define a color compensation layer, and the color compensation layer may define a surface of the reflector sheet.

In other embodiments, the color compensation material may be disposed inside of the reflector sheet.

In other embodiments, the light source may be disposed between the reflector sheet and the diffuser plate and may provide the white light to a bottom surface of the diffuser plate.

In another embodiment of the invention, a liquid crystal display (“LCD”) apparatus includes: an LCD panel which displays an image, where the LCD panel includes an array substrate, a counter substrate disposed opposite to the array substrate, and a liquid crystal layer disposed between the array substrate and the counter substrate; and a back light assembly which provides light to the LCD panel, where the back light assembly includes a light source including a light emitting diode which generates white light having color coordinates located on one of a plurality of color coordinate ranks, a reflector sheet including a reflective material which reflects light, and a color compensation material which compensates the color coordinates of the white light by controlling intensity of light having a predetermined wavelength range, among the white light, to allow the color coordinates of the white light to converge on target color coordinates, and a diffuser plate which diffuses light provided from the light source and the reflector sheet.

In other embodiments, the color compensation material may include one of absorption pigments, which absorb light having the predetermined wavelength among the white light, and a fluorescent body.

### BRIEF DESCRIPTION OF THE DRAWINGS

The above and other features of the invention will become more apparent by describing in further detail exemplary embodiments thereof with reference to the accompanying drawings, in which:

FIG. 1 is an exploded perspective view of an exemplary embodiment of a liquid crystal liquid (“LCD”), according to the invention;

FIG. 2 is a cross-sectional view taken along line I-I′ in FIG. 1;

FIG. 3 is a graph illustrating color coordinate ranks on a CIE color coordinate system;

FIG. 4 is a graph illustrating a light emitting spectrum of an exemplary embodiment of a light source, according to the invention;

FIG. 5 is a top view illustrating an exemplary embodiment of a reflector sheet, according to the invention;

FIG. 6 is a cross-sectional view illustrating the reflector sheet of FIG. 5; and

FIG. 7 is a cross-sectional view illustrating an alternative exemplary embodiment of a reflector sheet, according to the invention.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the invention will be described in detail with reference to the accompanying drawings.

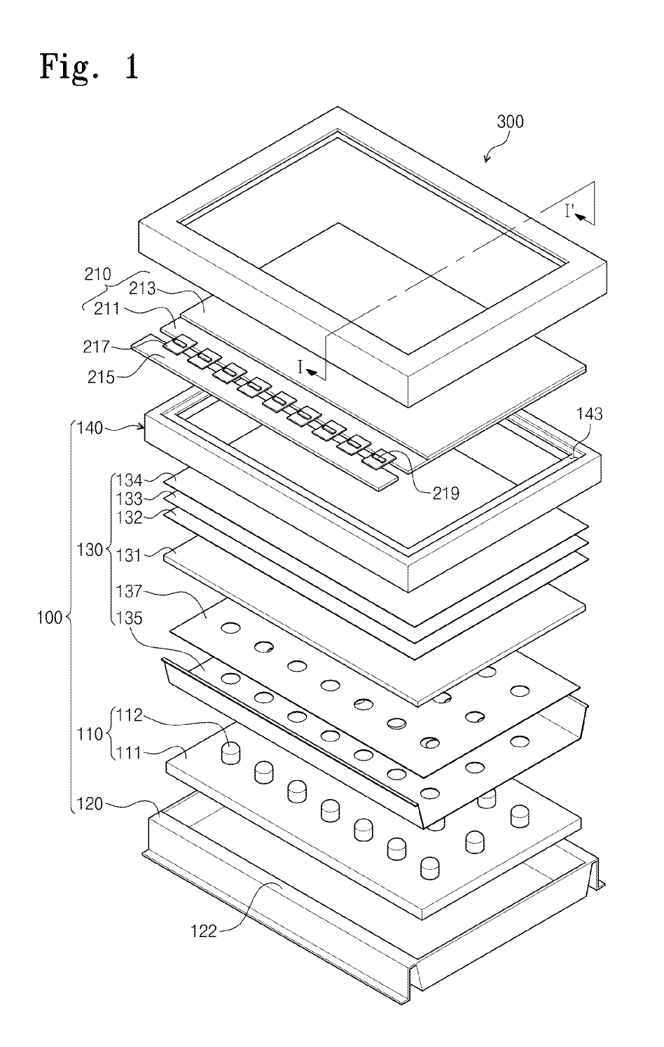

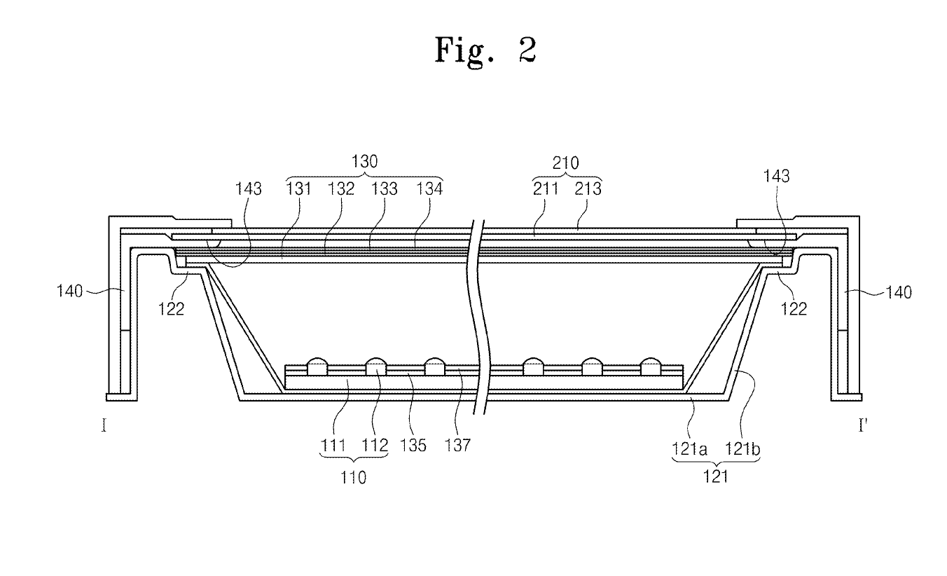

FIG. 1 is an exploded perspective view illustrating an exemplary embodiment of a liquid crystal display (“LCD”) apparatus 300, according to the invention, and FIG. 2 is a cross-sectional view taken along line I-I′ in FIG. 1.

Referring to FIGS. 1 and 2, the LCD apparatus 300 includes a back light assembly 100 that generates light, and an LCD panel 210 that receives the light from the back light assembly and thereby displays an image.

The LCD panel 210 includes an array substrate 211, a counter substrate 213 disposed opposite to, e.g., facing, the array substrate 211, and a liquid crystal layer (not shown) disposed between the array substrate 211 and the counter substrate 213.

The array substrate 211 may be a thin film transistor (“TFT”) substrate including TFTs, which are switching devices, arranged thereon substantially in a matrix form. A source terminal and a gate terminal of each of the TFTs are connected to a data line and a gate line, respectively, and a drain terminal each of the TFTs is connected to a pixel electrode including a transparent conductive material.

The counter substrate 213 may include a red, green and blue (“RGB”) color filter for realizing colors, a black matrix and a common electrode including a transparent conductive material.

The LCD apparatus 300 includes a printed circuit board (“PCB”) 215 that supplies a data driving signal and a gate driving signal to the LCD panel 210 and a driving circuit film 217 which connects the PCB 215 to the LCD panel 210.

The driving circuit film 217 may include one of a tape carrier package (“TCP”), on which a driving chip 219 is mounted, or a chip-on-film (“COF”)

The driving chip 219 may include a data driver that provides a data signal to the data line of the LCD panel 210 in response to the data driving signal. in such an embodiment, a gate driver (not shown) that provides a gate signal to the gate line of the LCD panel 210 in response to the gate driving signal may be provided in the LCD panel 210 by a thin film process.

The back light assembly 100 includes a light generation unit 110 that generates light, a storage element 120, an optical element 130 and a frame element 140.

The storage element 120 includes a storage part 121 that stores or accommodates the light generation unit 110 and a supporter 122 that supports the optical element 130. The storage part 121 includes a bottom surface 121a and a side wall 121b extending from the bottom surface 121a. The bottom surface 121a has a substantially tetragonal shape. The side wall 121b extends from an edge of the bottom surface 121a and thereby defines a storage space for storing the light generation unit 110. The storage element 120, for example, may include an aluminum-based metal that efficiently discharges heat generated from the light generation unit 110 outwardly and having substantially high strength and low deformation.

The optical element 130 includes optical sheets 132, 133 and 134, a diffuser plate 131 and a reflector sheet 135. The diffuser plate 131 has a plate shape, is guided by a guide (not shown) and is disposed on a predetermined position on the supporter 122. Accordingly, the diffuser plate 131 is disposed above the light generation unit 110 and diffuses light emitted from the light generation unit 110, thereby substantially improving uniformity in brightness. In such an embodiment, the diffuser plate 131 may support the optical sheets 132, 133 and 134 not to move downwardly.

The optical sheets 132, 133 and 134 may be disposed on the diffuser plate 131 and may include a sheet that improves brightness properties of light emitted from the diffuser plate 131. In one exemplary embodiment, for example, the optical sheets 132, 133 and 134 may include one diffusion sheet 132 for diffusing light and two condensing sheets 133 and 134 for condensing light.

The diffusion sheet 132 is disposed on the diffuser plate 131 and diffuses light emitted from the diffuser plate 131. The diffusion sheet 132 may include a transparent material, such as polyethylene terephthalate, for example.

The condensing sheets 133 and 134 are disposed above the diffusion sheet 132 and condense light diffused through the diffusion sheet 132, thereby substantially improving front brightness. In one exemplary embodiment, for example, each of the condensing sheets 133 and 134 may include a micro prism pattern (not shown) having a prism shape. In such an embodiment, a prism pattern extending substantially in a first direction may be provided in one of the condensing sheets 133 and 134 and a prism pattern extending substantially in a second direction, which is perpendicular to the first direction, may be provided in the other of the condensing sheets 133 and 134.

The back light assembly 100 includes a frame element 140 disposed between the optical element 130 and the LCD panel 210. The frame element 140 is coupled with the storage element 120, fastens the optical element to the storage element 120, and effectively prevents the diffuser plate 131 from moving in a space between the storage element 120 and the frame element 140.

In an exemplary embodiment, the frame element 140 supports the LCD panel 210. In such an embodiment, the frame element 140 further includes a panel guide 143, on which the LCD panel 210 is disposed. In such an embodiment, the panel guide 143 supports the LCD panel 210 disposed thereon.

In an exemplary embodiment, the LCD apparatus 300 further includes a top chassis 230 coupled with the frame element 140, which is disposed opposite to the top chassis 230. In such an embodiment, the top chassis 230 fastens the LCD panel 210 to the frame element 140. The top chassis 230 surrounds an edge of the LCD panel 210 and fastens the LCD panel 210 to the panel guide 143 of the frame element 140. Accordingly, the top chassis 230 effectively prevents a damage of the LCD panel 210 caused by an external shock and effectively prevents a separation of the LCD panel 210 from the panel guide 143 of the frame element 140.

The light generation unit 110 includes a circuit board 111 and a plurality of light sources 112 disposed, e.g., mounted, on the circuit board 111. The circuit board 111 is disposed in the storage part 121 and faces the optical element 130. The light sources 112 may be arranged substantially in a matrix form on the circuit board 111. The light sources 112 may have a direct type structure, that is, are disposed between the reflector sheet 135 and the diffuser plate 131 and provide light to a bottom of the diffuser plate 131.

The light sources 112 disposed on the circuit board 111 provide white light toward the optical element 130 and the reflector sheet 135. Each of the light sources 112 may include a white light emitting diode that emits white light. The white light emitting diode, for example, emits white light by mixing light of two complementary colors. In one exemplary embodiment, for example, the white light emitting diode includes a blue luminous body that emits blue light and a light source fluorescent body. The blue luminous body may be a blue light emitting diode chip, and the light source fluorescent body is excited by light of the blue luminous body and emits yellow light, which is a complementary color of the blue light. The blue light emitted from the blue luminous body and the yellow light emitted from the light source fluorescent body are mixed with each other to thereby generate white light.

The reflector sheet 135 is disposed on a top surface of the circuit board 111, that is, a surface on which the light source 112 is mounted. A first opening may be defined, e.g., formed, in a region of the reflector sheet, corresponding to an area where the light sources 112 are disposed.

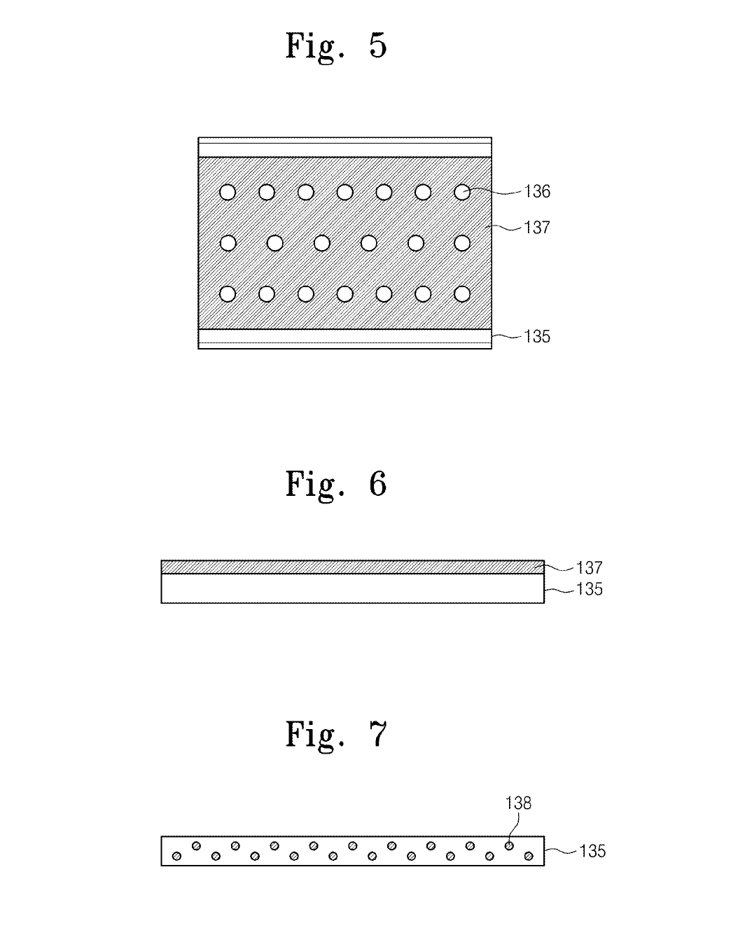

The reflector sheet 135 reflects white light leaking below the light generation unit 110 toward the optical element 130, thereby substantially improving efficiency of using light. The reflector sheet 135 includes a reflective material that reflects incident light and a color compensation material. In one exemplary embodiment, for example, the reflector sheet 135 may include a reflective material, e.g., polyethylene terephthalate (“PET”) and poly carbonate (“PC”). The color compensation material may be included in a color compensation layer 137 that covers a top surface of the reflector sheet 135. The color compensation material and the color compensation layer 137 will be described later in greater detail with reference to FIGS. 5 to 7.

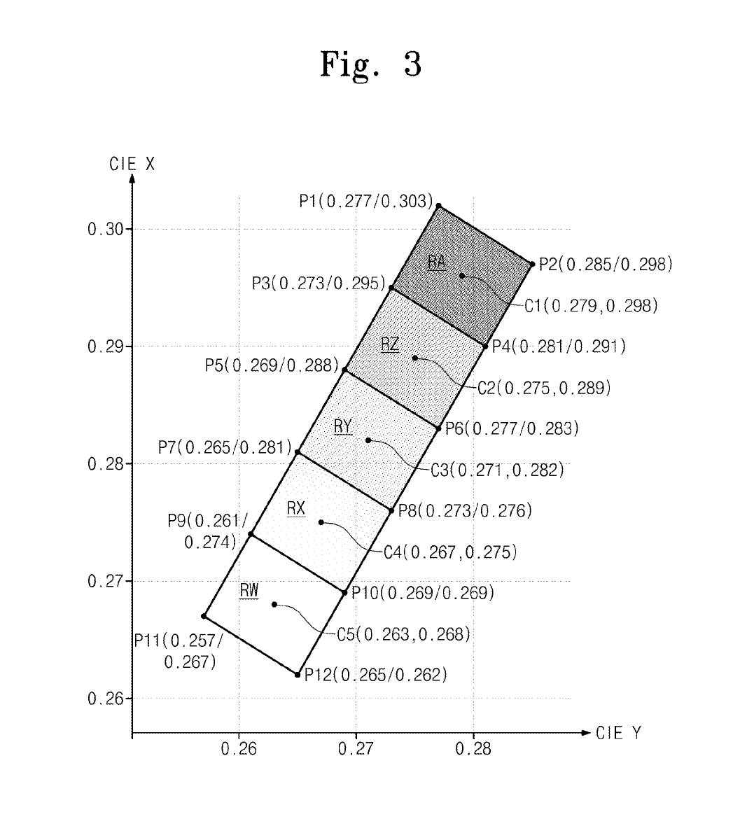

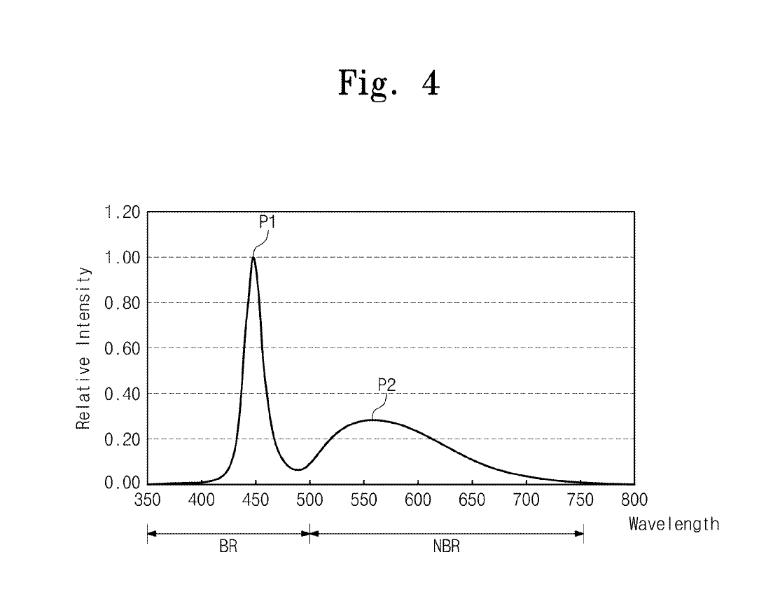

FIG. 3 is a graph illustrating color coordinate ranks on a CIE color coordinate system, and FIG. 4 is a graph illustrating a light emitting spectrum of an exemplary embodiment of the light source 112, according to the invention.

Referring to FIG. 3, a color coordinate value of white light emitted by the light source 112, e.g., a white light emitting diode, may be located on any of a plurality of color coordinate ranks. In an exemplary embodiment, the back light assembly 100 includes light emitting diodes that emit white light located only on a same color coordinate rank as each other. In such an embodiment, color coordinates of white light emitted from the back light assembly 100 is determined based on color coordinates of the white light of the light emitting diodes included in the back light assembly 100.

Distribution of a dominant wavelength P1 (refer to FIG. 4) of a blue light emitting diode chip and distribution of a fluorescent wavelength P2 (refer to FIG. 4) caused by a difference in the content of a light source fluorescent body is determined during a process of manufacturing a light emitting diode, such that color coordinates of white light from the light emitting diodes are broadly distributed on the CIE coordinate system according to light emitting properties of the light emitting diodes, as shown in FIG. 3. Accordingly, based on the light emitting properties, a color coordinate value of white light emitted by a white light emitting diode is located on one of a plurality of color coordinate ranks RW, RX, RY, RZ and RA divided in the color coordinate system.

The respective color coordinate ranks are divided based on color coordinates or chromaticity, and each area indistinguishable by human eyes is subdivided as the same color coordinate rank. In the graph, the plurality of color coordinate ranks is divided into W, X, Y, Z and A color coordinate ranks RX, RY, RZ and RA based on as values of an x-coordinate and a y-coordinate of the CIE color coordinates. As shown in FIG. 3, the W, X, Y, Z and A color coordinate ranks RX, RY, RZ and RA are defined as values of the x-coordinate and the y-coordinate of the CIE color coordinates increase.

As shown in FIG. 3, the W color coordinate rank (RW) may be defined as an area of a first trapezoid with a W central point (C5)(0.263, 0.268) as a center and with vertexes P9(0.261, 0.274), P10(0.269, 0.269), P11(0.257, 0.267) and P12(0.265, 0.262) and includes color coordinates located in the area of the first trapezoid.

The X color coordinate rank (RX) may be defined as an area of a second trapezoid with an X central point (C4)(0.267, 0.275) as a center and with vertexes P9(0.261, 0.274), P10(0.269, 0.269), P7(0.265, 0.281) and P8(0.273, 0.276) and includes color coordinates located in the area of the second trapezoid.

The Y color coordinate rank (RY) may be defined as an area of a third trapezoid with a Y central point (C3)(0.271, 0.282) as a center with vertexes P8(0.273, 0.276), P7(0.265, 0.281), P5(0.269, 0.288) and P6(0.277, 0.283) and includes color coordinates located in the area of the third trapezoid.

The Z color coordinate rank (RZ) may be defined as an area of a fourth trapezoid with a Z central point (C2)(0.275, 0.289) as a center with vertexes P5(0.269, 0.288), P6(0.277, 0.283), P3(0.273, 0.295) and P4(0.281, 0.291) and includes color coordinates located in the area of the fourth trapezoid.

The A color coordinate rank (RA) may be defined as an area of a fifth trapezoid with A central point (C1)(0.279, 0.298) as a center with vertexes P3(0.273, 0.295), P4(0.281, 0.291), P1(0.277, 0.303) and P2(0.285, 0.298) and includes color coordinates located in the area of the fourth trapezoid. As shown in FIG. 3, the plurality of color coordinate ranks RW, RX, RY, RZ and RA may not overlap one another. However, a subdivision of the color coordinate ranks is not limited thereto and may be differently defined or divided.

Referring to FIG. 4, the light emitting spectrum of the light source 112 includes the dominant wavelength P1 and the fluorescent wavelength P2. The dominant wavelength P1 is generated by the blue light emitting diode chip and is distributed in a blue region BR, and the fluorescent wavelength P2 is generated by the light source fluorescent body and distributed in a non-blue region NBR. The blue region BR corresponds to a range of a wavelength from about 350 nanometers (nm) to about 500 nm, and the non-blue region NBR corresponds to a range of a wavelength from about 500 nm to about 800 nm. The distribution of the fluorescent wavelength P2 is subordinate to an amount of the light source fluorescent body in the light emitting diode. Accordingly, an x-coordinate value and a y-coordinate value of color coordinates of white light emitted by the light emitting diode vary based on the amount of the light source fluorescent body. In an exemplary embodiment, the color coordinate ranks RW, RX, RY, RZ and RA, in which the color coordinates of the light emitting diode are located, may change based on the amount of the light source fluorescent body.

FIG. 5 is a top view illustrating an exemplary embodiment of the reflector sheet 135, and FIG. 6 is a cross-sectional view illustrating the reflector sheet 135 shown in FIG. 5.

Referring to FIGS. 5 and 6, an exemplary embodiment of the reflector sheet 135 includes the color compensation layer 137. The color compensation layer 137 allows color coordinates of white light incident on the color compensation layer 137 to converge on target color coordinates. The color compensation layer 137 may be disposed, e.g., coated, on a surface of the reflector sheet 135 and includes a color compensation material.

In such an embodiment, a second opening 136 is defined in a region of the color compensation layer 137 to correspond to the first opening in the reflector sheet 135. Accordingly, each of the light sources 112 are inserted into a corresponding second opening 136 and face the diffuser plate 131.

The color compensation material in the color compensation layer 137 controls the intensity of light having a predetermined wavelength range among white light and allows color coordinates of the white light to converge on the target color coordinates. A color coordinate rank of the white light, on which a color coordinate value of the white light is located, is in one of the color coordinate ranks RW, RX, RY, RZ and RA. A color coordinate rank, on which a target color coordinate value is located, is in one of the color coordinate ranks RW, RX, RY, RZ, and RA. The target color coordinate may be in a color coordinate rank having high x-coordinate value and/or y-coordinate value, such as the A color coordinate rank RA as brightness increases when the x-coordinate value and/or the y-coordinate value are high such as the A color coordinate rank RA. In one exemplary embodiment, for example, the color coordinates of the white light is in the X color coordinate rank RX and the target color coordinates is in the A color coordinate rank RA, the color coordinates of the white light may be allowed to converge on the target color coordinates by increasing the intensity of light having a long wavelength range of the white light or reducing the intensity of light having a short wavelength range of the white light.

The color compensation material in the color compensation layer 137 may include absorption pigments. The absorption pigments compensate the color coordinate value of the white light by absorbing light having a predetermined wavelength among the white light. In one exemplary embodiment, for example, the absorption pigments increase at least one of the x-coordinate value and the y-coordinate value of the white light when the x-coordinate value of the color coordinates of the white light is less than an x-coordinate value of the target color coordinates or the y-coordinate value of the color coordinates of the white light is less than a y-coordinate value of the target color coordinates. In such an embodiment, the absorption pigments have an absorption spectrum that overlaps at least a portion of a light emitting spectrum of the blue region BR (shown in FIG. 4) among light emitting spectrums of the white light. Accordingly, in such an embodiment, where the absorption pigments absorb a portion of the white light, the wavelength of which is within the blue region BR, at least one of the x-coordinate value and the y-coordinate value of the color coordinates of the white light may be increased.

In such an embodiment, the absorption pigments may absorb light having a wavelength in a range from about 350 nm to about 500 nm among white light incident from the light source 112. An absorption spectrum of the absorption pigments may have absorption intensity in a range of about 10% or less of maximum absorption intensity of the absorption pigments, at a wavelength of about 500 nm. Accordingly, the absorption pigments effectively prevent the white light having a wavelength within the non-blue region NBR having a great effect on the brightness from being absorbed, thereby effectively preventing a reduction of brightness of the white light. In such an embodiment, when the light emitting diode emits light having a wavelength in a range from about 430 nm to about 450 nm, a wavelength of the absorption pigments having the maximum absorption intensity is within a range from about 430 nm to about 450 nm and a half-width of the absorption spectrum of the absorption pigments is in a range from about 15 nm to about 30 nm. In one exemplary embodiment, for example, the absorption pigments may include azo pigments, phthalocyanine pigments, dye mordant pigments, condensed polycyclic pigments, or a combination thereof.

In an alternative exemplary embodiment, the absorption pigments may reduce at least one of the x-coordinate value and the y-coordinate value of the white light when the x-coordinate value of the color coordinates of the white light is greater than an x-coordinate value of the target color coordinates or the y-coordinate value of the color coordinates of the white light is greater than a y-coordinate value of the target color coordinates. In such an embodiment, the absorption pigments have an absorption spectrum that overlaps at least a portion of a light emitting spectrum of the non-blue region NBR (shown in FIG. 4) among light emitting spectrums of the white light. Accordingly, in such an embodiment, where the absorption pigments absorb a portion of the white light, the wavelength of which is within the non-blue region NBR, at least one of the x-coordinate value and the y-coordinate value of the color coordinates of the white light may be decreased. The absorption pigments may absorb light having a wavelength from about 500 nm to about 800 nm, among the white light.

As described above, the color compensation material may allow the color coordinates of the white light to converge on the target color coordinates based on the absorption spectrum of the absorption pigments, which is different according to the color coordinates of the white light.

In an exemplary embodiment, the reflector sheet 135 including the color compensation material allows the white light to converge on the target color coordinates, thereby substantially uniformly maintaining back light and color coordinates of white gradations displayed on the LCD panel 210. In an exemplary embodiment, the color coordinates of the white gradations displayed on the LCD panel 210 and the color coordinates of the back light depend on the color coordinates of the white light. In such an embodiment, as described above, since the color coordinates of the white light may be compensated by the color compensation material to the target color coordinates, the color coordinates of the white gradations emitted by the LCD panel 210 and the color coordinates of the back light may be compensated to be predetermined color coordinates, e.g., color coordinates corresponding to the target color coordinates of the white light, by setting the target color coordinate value.

In an exemplary embodiment, any light emitting diode may be used as a light source independently of a color coordinate rank of the light emitting diode, on which color coordinates of white light is located, the reflector sheet 135 including the color compensation material may substantially improve yields of the light emitting diodes.

In an alternative exemplary embodiment, the color compensation material may include a fluorescent body that generates fluorescence, for example. The fluorescent body generates fluorescence and compensates the color coordinates of the white light.

In such an embodiment, when an x-coordinate value of the color coordinates of the white light is greater than an x-coordinate value of the target color coordinates or a y-coordinate value of the color coordinates of the white light is greater than a y-coordinate value of the target color coordinates, the fluorescent body reduces at least one of the x-coordinate value and the y-coordinate value of the white light. The fluorescent body generates light having a wavelength within the blue region BR and may generate light having a wavelength in a range from about 350 nm to about 500 nm. Accordingly, when the fluorescent body generates the light having the wavelength within the blue region BR, at least one of the x-coordinate value and the y-coordinate value of the color coordinates of the white light may be reduced.

In such an embodiment, when the x-coordinate value of the color coordinates of the white light is less than the x-coordinate value of the target color coordinates or the y-coordinate value of the color coordinates of the white light is less than the y-coordinate value of the target color coordinates, the fluorescent body increases at least one of the x-coordinate value and the y-coordinate value of the white light. The fluorescent body generates light having a wavelength within the non-blue region NBR and may generate light having a wavelength in a range from about 500 nm to about 800 nm. Accordingly, when the fluorescent body generates light having a wavelength within the non-blue region NBR, at least one of the x-coordinate value and the y-coordinate value of the color coordinates of the white light may be increased.

As described above, the fluorescent body included in the color compensation layer 137 may be differently set based on the color coordinates of the white light, thereby allowing the color coordinates of the white light to converge on the target color coordinates independently of the color coordinates of the white light.

FIG. 7 is a cross-sectional view illustrating an alternative exemplary embodiment of the reflector sheet 135. Referring to FIG. 7, the reflector sheet 135 may include a color compensation material 138 provided therein, e.g., disposed inside of the reflector sheet 135. Since the color compensation material 138 is substantially the same as the color compensation material in the color compensation layer 137 of the exemplary embodiment of the reflector sheet 135 described above with reference to FIGS. 5 and 6, any repetitive description thereof will be omitted. In such an embodiment, the color compensation material 138 is substantially uniformly distributed throughout the reflector sheet 135. In an exemplary embodiment of a method of manufacturing the reflector sheet 135, the color compensation material 138 is uniformly mixed with a reflective material such as polyethylene terephthalate (“PET”), for example, and a reflector sheet manufacturing material including the color compensation material 138 is processed, thereby manufacturing the reflector sheet 135.

Accordingly, in such an embodiment, the white light incident from the light source 112 to the reflector sheet 135 is not directly reflected by a surface of the reflector sheet 135 and penetrates the reflector sheet 135 to a certain depth therein.

In such an embodiment, the color compensation material 138 compensates a color coordinate value of the white light penetrating the reflector sheet 135 to be a target color coordinate value. The white light compensated with the color coordinate value is reflected toward the optical element 130 by a reflective material (not shown).

According to exemplary embodiments of the invention as described herein, the back light assembly and the LCD apparatus including the back light assembly allow a color coordinate value of white light generated by a light source to converge on a target color coordinate value by a reflector sheet that compensates color of the white light. Accordingly, a color coordinate value of back light may be substantially uniformly maintained independently of the color coordinate value of the white light emitted from the light source.

The above-disclosed subject matter is to be considered illustrative and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A back light assembly comprising:
a light source comprising a light emitting diode which generates white light having color coordinates located on one of a plurality of color coordinate ranks;
a reflector sheet which reflects the white light incident from the light source, wherein the reflector sheet comprises:
a reflective material which reflects light incident thereon; and
a color compensation material which compensates the color coordinates of the white light by controlling intensity of light having a predetermined wavelength range, among the white light, to allow the color coordinates of the white light to converge on target color coordinates; and
a diffuser plate which diffuses light provided from the light source and the reflector sheet.

2. The back light assembly of claim 1, wherein the color compensation material comprises absorption pigments which absorb the light having the predetermined wavelength among the white light.

3. The back light assembly of claim 2, wherein
an x-coordinate value of the color coordinates of the white light is less than an x-coordinate value of the target color coordinates or a y-coordinate value of the color coordinates of the white light is less than a y-coordinate value of the target color coordinates, and
the absorption pigments increase at least one of the x-coordinate value and the y-coordinate value of the color coordinates of the white light.

4. The back light assembly of claim 3, wherein the absorption pigments absorb light having a wavelength in a range from about 350 nanometers to about 500 nanometers, among the white light.

5. The back light assembly of claim 4, wherein an absorption spectrum of the absorption pigments has absorption intensity of about 10% or less of maximum absorption intensity of the absorption pigments, at a wavelength of about 500 nanometers.

6. The back light assembly of claim 3, wherein an absorption spectrum of the absorption pigments overlaps at least a portion of a blue light emitting spectrum among light emitting spectrums of the light emitting diode.

7. The back light assembly of claim 6, wherein
the light emitting diode generates light having a wavelength in a range from about 430 nanometers to about 450 nanometers,
a wavelength of the absorption pigments having maximum absorption intensity is within a range from about 430 nanometers to about 450 nanometers, and
a half width of the absorption spectrum of the absorption pigments is in a range from about 15 nanometers to about 30 nanometers.

8. The back light assembly of claim 2, wherein the absorption pigments comprise azo pigments, phthalocyanine pigments, dye mordant pigments, condensed polycyclic pigments, or a combination thereof.

9. The back light assembly of claim 2, wherein
an x-coordinate value of the color coordinates of the white light is greater than an x-coordinate value of the target color coordinates or a y-coordinate value of the color coordinates of the white light is greater than a y-coordinate value of the target color coordinates, and
the absorption pigments reduce at least one of the x-coordinate value and the y-coordinate value of the color coordinates of the white light.

10. The back light assembly of claim 9, wherein the absorption pigments absorb light having a wavelength in a range from about 500 nanometers to about 800 nanometers among the white light.

11. The back light assembly of claim 1, wherein the color compensation material comprises a fluorescent body.

12. The back light assembly of claim 11, wherein
an x-coordinate value of the color coordinates of the white light is less than an x-coordinate value of the target color coordinates or a y-coordinate value of the color coordinates of the white light is less than a y-coordinate value of the target color coordinates, and
the fluorescent body increases at least one of the x-coordinate value and the y-coordinate value of the color coordinates of the white light.

13. The back light assembly of claim 12, wherein the fluorescent body generates light comprising light having a wavelength in a range from about 500 nanometers to about 800 nanometers.

14. The back light assembly of claim 11, wherein
an x-coordinate value of the color coordinates of the white light is greater than an x-coordinate value of the target color coordinates or a y-coordinate value of the color coordinates of the white light is greater than a y-coordinate value of the target color coordinates, and
the fluorescent body reduces at least one of the x-coordinate value and the y-coordinate value of the color coordinates of the white light.

15. The back light assembly of claim 14, wherein the fluorescent body generates light comprising light having a wavelength in a range from about 350 nanometers to about 500 nanometers.

16. The back light assembly of claim 1, wherein
the color compensation material of the reflector sheet defines a color compensation layer, and
the color compensation layer defines a surface of the reflector sheet.

17. The back light assembly of claim 1, wherein the color compensation material is disposed inside of the reflector sheet.

18. The back light assembly of claim 1, wherein the light source is disposed between the reflector sheet and the diffuser plate and provides the white light to a bottom surface of the diffuser plate.

19. A liquid crystal display apparatus comprising:
a liquid crystal display panel which displays an image, wherein the liquid crystal display panel comprises:
an array substrate;
a counter substrate disposed opposite to the array substrate; and
a liquid crystal layer disposed between the array substrate and the counter substrate; and
a back light assembly which provides light to the liquid crystal display panel, wherein the back light assembly comprises:
a light source comprising a light emitting diode which generates white light having color coordinates located on one of a plurality of color coordinate ranks;
a reflector sheet which reflects the white light incident from the light source, wherein the reflector sheet comprises:
a reflective material which reflects light incident thereon; and
a color compensation material which compensates the color coordinates of the white light by controlling intensity of light having a predetermined wavelength range, among the white light, to allow the color coordinates of the white light to converge on target color coordinates; and
a diffuser plate which diffuses light provided from the light source and the reflector sheet.

20. The liquid crystal display apparatus of claim 19, wherein the color compensation material comprises one of absorption pigments, which absorbs light having the predetermined wavelength among the white light, and a fluorescent body.
